(19) United States
(12) Patent Application Publication
(10) Pub. No.: US 2012/0030955 A1
(43) Pub. Date: Feb. 9, 2012

(54) Motor Driver Power Tool

(75) Inventors: Hans Kaiser, Leuzigen (CH); Marcel Casota, Leuzigen (CH)

(73) Assignee: Robert Bosch GmbH, Stuttgart (DE)

(21) Appl. No.: 13/143,292

(22) PCT Filed: Nov. 17, 2009
(86) PCT No.: PCT/EP2009/065306

§ 371 Date: Oct. 26, 2011

(30) Foreign Application Priority Data
Jan. 5, 2009 (DE) 102009000034.8

(51) Int. Cl. B23D 51/16; B23D 49/16

(52) U.S. Cl. 30/393; 173/213

(57) ABSTRACT

A machine tool, in particular a keyhole saw, includes a support frame that is twistably supported on the housing and forms the guide for a linear sliding part of the lifting drive unit for the working tool. The linear sliding part is mounted on the lifting rod.

The invention relates to a motor driven power tool, in particular a hand-held power tool, according to the preamble of claim 1.

### PRIOR ART

Motor driven power tools of the aforementioned type are known from DE 37 02 670 A1. They are comparatively complex in their structure, and have a lifting rod, which projects upwardly over the stroke drive and, at its upper end, at which the rotary drive for the lifting rod and for the working tool connected to the latter in a rotationally fixed manner is applied, is mounted so as to be pivotable about an axis running transversely in relation to the working plane of the tool, in order to execute the pendulum stroke operation. Overall, this results, in the longitudinal direction of the lifting rod also, in a structural length that is undesirable in some cases and that can give rise to a certain susceptibility to faults, particularly under demanding working conditions. In particular, it is at least also difficult to operate a power tool of this structure in pendulum stroke operation with the working tool rotated about its longitudinal axis to the straight ahead working direction.

### Disclosure of the Invention

The invention is based on the object of simplifying in its structure a motor driven power tool of the type mentioned at the outset and, additionally, of configuring it, with a compact and robust structure, such that a pendulum stroke operation is possible, if required, with the working plane of the working tool rotated about its longitudinal axis to the straight ahead working direction, i.e., therefore, a “scrolling” operation.

This object is achieved, according to the invention, by means of the features of claim 1. The dependent claims specify expedient developments.

In the case of the power tool configuration according to the invention, the tool driven in stroke motion is set, in its rotary position about the longitudinal axis that corresponds, at least substantially, to its stroke axis, via a carrier frame driven in rotary motion that, at the same time, is a carrier of a support member provided at the back in relation to the working tool and supporting the latter, and that additionally also constitutes the guidance and support for a drive part of the stroke drive on the lifting rod side, to which drive part the lifting rod is connected about a pivot axis running transversely in relation to its working plane. In summary, therefore, the rotary and stroke guidance of the working tool, realized, in particular, as a saw blade, and of the associated lifting rod is effected via the carrier frame that is to be driven rotatably and is mounted on the housing side, as a result of which it is also possible to realize a comparatively short lifting rod, which, in combination with the axial guidance and rotary support of the drive part of the stroke drive on the lifting rod side in relation to the carrier frame, also results in a very stiff design, with a simple structure.

The thereby created conditions for a directionally stable guidance of the working tool without sensitivity to vibrations are further improved in that the carrier frame is also a carrier of the support member that, at the back, supports the working tool in the working plane, irrespective of the respective rotary position, as a result of which, in particular, transverse forces on the working tool can also be controlled particularly well. Overall, a machine structure is thus obtained that, even in the case of rotary displacement of the working tool about its longitudinal axis, enables a respectively defined working line to be followed exactly by rotation of the working tool about its longitudinal axis, such that a machine designed in such a manner is also suitable, in particular, for semiautomatic application, wherein the alignment to a working line is effected by rotating the tool. Overall, a good working result can thus be achieved in all working modes, thus in straight ahead sawing or in pendulum stroke operation and also in so-called “scrolling”, the supporting of the working tool via the carrier frame against the housing also ensuring a favorable load bearing, and this in combination with a simple rotary displacement capability.

The combination, according to the invention, of the various support and guide functions on the carrier frame is also favorable because, via the ring-shaped carrier frame, support in respect of the housing can also be effected on a broad base, this being irrespective of the respective rotary position of the working tool, such that the support and guidance conditions do not change in dependence on rotary length, which is advantageous, in particular, in respect of the pendulum stroke operation that is also expedient in the case of a “scrolling” working mode.

Owing to the circular-ring shape of the carrier frame, its mounting in respect of the housing is likewise configured in a simple manner, this design offering the possibility of supporting the carrier frame in two bearing planes, which are preferably assigned to the upper and the lower end of the carrier frame, and in which the carrier frame, in the case of a cage-type structure, has an upper and a lower carrier ring. Going out from the lower carrier ring are the carrier limbs, on which the support member is mounted in a pivotally movable manner, which support member, in the case of an overall preferred Z-shaped basic shape in the region of its arm that is at a distance from and projects from the working tool, is acted upon by a positioning element of the positioning drive provided for the pendulum drive, preferably with the positioning element extending parallelwise in relation to the longitudinal axis of the working tool.

For exact guidance of the working tool, an additional, transverse guide for the lifting rod can also be provided, furthermore, in the transition region to the tool holder, in particular in the region of the lower carrier ring. This transverse guide can be constituted, for example, by a web-type insert having a longitudinal cutout running in the pendulum direction of the lifting rod, or by a base-type insert to the lower carrier ring, which insert would likewise be provided with a corresponding recess.

Also contributing to the stability of the power tool and to the exact guidance of the working tool is the fact that, in the case of the solution according to the invention, the stroke drive is supported separately from the housing in respect of its drive part, and that the lifting rod of the stroke drive, with the drive part of the stroke drive that is on the lifting rod side, is assigned to the carrier frame that is supported separately from the housing.

In the case of the solution according to the invention, the crank drive is realized, in particular, as a Scotch-yoke crank drive, having guides for a yoke part that run parallelwise in relation to the longitudinal axis, the yoke of which yoke part runs, perpendicularly in relation to the working plane, between the guides. Accessing the yoke is the eccentric drive of the drive wheel provided for the stroke drive, which drive wheel, with the working tool, the carrier frame, the yoke part and the guides for the yoke part, is located at the front in relation to a carrier plate, located at the back in relation to which there is a positionally fixed positioning drive for the pendulum stroke mode, i.e. the pendulum drive, which, by means of its drive element, in particular in the form of a pin, acts upon the arm, as a positioning sector, projecting at the back in relation to the support member.

In respect of the angular position of the yoke part in relation to the eccentric pin, which angular position varies with the rotary position of the working tool, and therefore also of the carrier frame, it is expedient if the eccentric pin is supported via a needle bearing in relation to the guide yoke, in particular is realized as a needle bearing in its engagement part in relation to the guide yoke.

Overall, in the case of the configuration according to the invention, a relatively short and compact structure can be achieved in the direction of the lifting rod, which structure can be realized in a manner that is also structurally favorable in respect of the drive guides for the stroke drive, the pendulum drive and also the rotary displacement of the carrier frame.

Further advantages and expedient realizations are given by the claims, the description of the figures and the drawings, wherein:

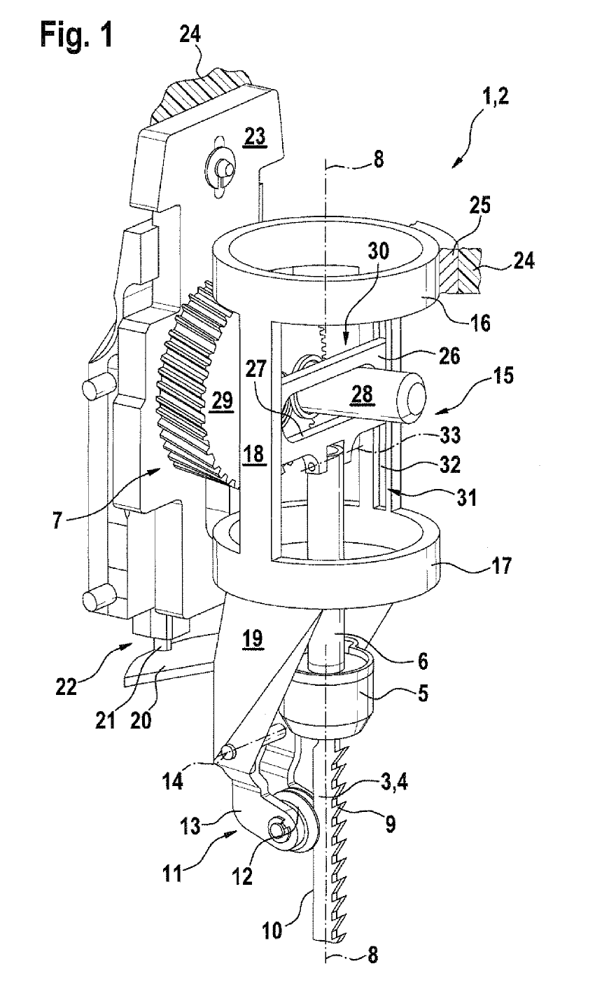

FIG. 1 shows a perspective, schematic general representation of a power tool according to the invention, in the form of a jigsaw, reduced to the parts essential for understanding of the invention, the housing not being represented, and

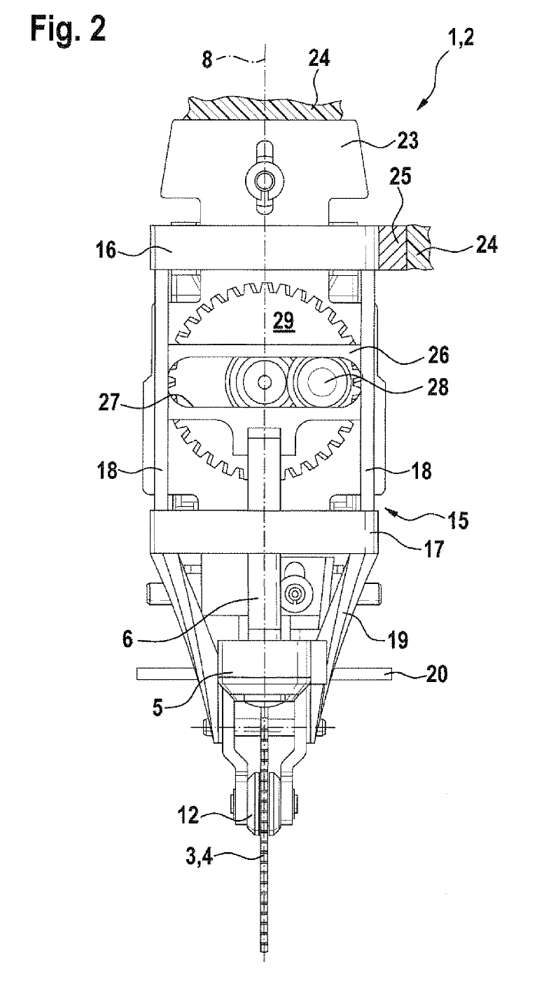

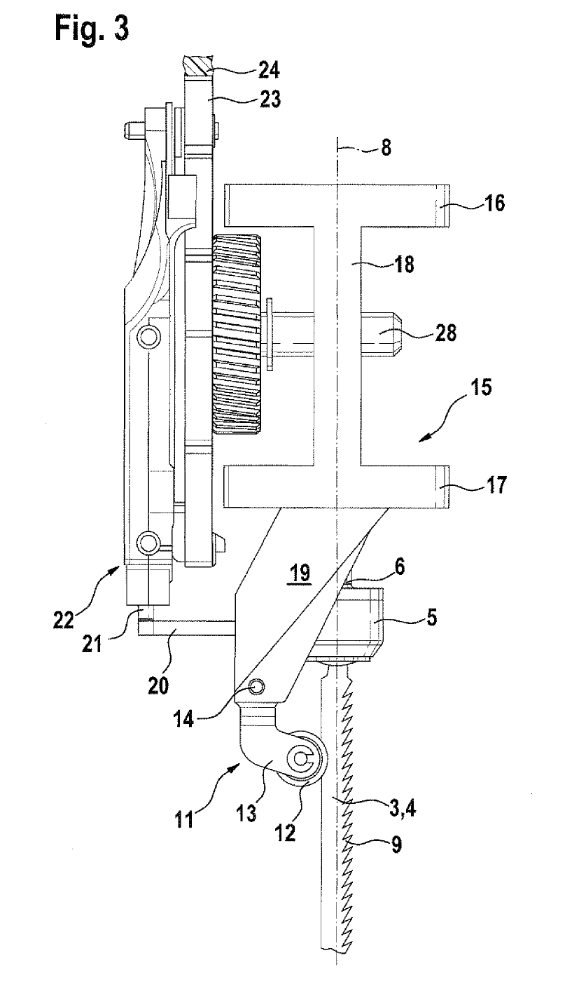

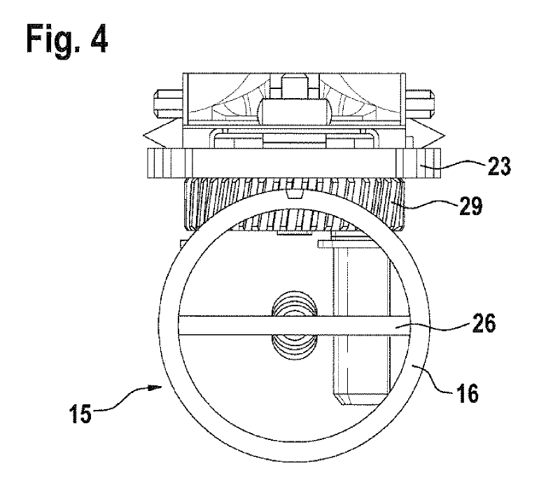

FIGS. 2 to 4 show representations of the power tool according to FIG. 1 in a front view, side view and top view.

Shown in the figures, represented in a simplified manner and without a housing, is a power tool 1 in the form of a jigsaw 2, the working tool 3 of which is constituted by a saw blade 4 driven in a stroke motion. The saw blade 4 is connected to the lifting rod 6 of a stroke drive 7 via a saw blade receiver 5.

The saw blade 4—as a working tool 3—has a longitudinal axis 8, which lies in the working plane of the saw blade 4. On the front side, the saw blade is provided with a toothing 9, the saw blade back, on the opposite side, being denoted by 10. A support member 11 is supported, via a support roller 12, against the saw blade back 10. The support member 11 is constituted by a pivot lever 13, which is linked to a carrier frame 15 via a pivot axis 14.

The carrier frame 15 is designed in the manner of a cage, and has an upper carrier ring 16 and a lower carrier ring 17, between which, in the exemplary embodiment, there extend two longitudinal struts 18. Provided on the lower carrier ring 17 are two carrier limbs 19, which project downwardly and are opposite one another relative to the working plane that includes the longitudinal axis 8 of the working tool 3, and between which there extends the pivot axis 14 carried via these carrier limbs.

The support member 11, which has an overall Z shape, has an arm that constitutes a position sector 20 projecting in the direction opposite to the working tool 4. In the case of a stroke direction of the positioning element 20 that is parallel to the longitudinal axis 8, the positioning element 21 of a positioning drive 22 is supported on the positioning sector 20. The positioning sector 20 extends over an angular range corresponding to the pivoting range of the working tool about its longitudinal axis 8, which angular range is usually approximately ±30°.

The positioning drive 22 is located at the back in relation to a carrier plate 23 that is fixed to the housing 24, indicated in schematic form only, and provided opposite are the shown parts of the stroke drive 7, the carrier frame 15, and the support member 11 that acts upon the working tool 3 from the back. The positioning sector 20 extends so as to engage beneath and overlap the carrier plate 23.

Via a pivot axis 33 that runs transversely in relation to the working plane, the lifting rod 6 is connected to the yoke part 26, which constitutes part of the drive part of the stroke drive 7 on the lifting rod side, and which has a yoke guide 27, which lies in the working plane and in which there engages an eccentric pin 28 of a drive wheel 29. The drive wheel 29, realized as a toothed wheel, is connected in a driving manner, not shown in greater detail, to a drive motor and, with its eccentric pin 28, constitutes a part of the crank drive 30.

The longitudinal struts 18 of the carrier frame 15 that is constructed in the manner of a cage constitute, for the yoke part 26, a slide guide 31 extending in the working plane, and in whose groove-type guideways 32 there engage the front ends of the yoke part 26 that are opposite one another in the direction of the working plane.

It is not shown that the eccentric pin 28 is preferably realized as a needle bearing, or carries a needle bearing, this realization of the eccentric pin 28 preferably being provided only for the longitudinal region of the same, which longitudinal region, owing to the pivot motion of the carrier frame 15 during rotary drive of the same, is swept over by the yoke part 26.

The mounting of the carrier frame 15 in relation to the housing 24 is not shown in detail in the figures, but is indicated schematically through assignment of a bearing 25 to the upper carrier ring 16, on which there also preferably acts the rotary drive for pivoting the carrier frame 15 about the longitudinal axis 8. For this purpose, the upper carrier ring 16 can be provided with an inner toothing, which is accessed by a drive pinion of the rotary drive, this constituting a particularly simple solution that is also favorable in respect of space. Clearly, it is within the scope of the invention for the carrier frame 15 to be supported on the housing side via a mounting provided to the carrier ring 17, and possibly also to effect a bearing support in relation to the housing 24 in the region of the upper and the lower carrier ring 16, 17.

1. A motor driven power tool, comprising a housing and a working tool, which has a working plane that includes its longitudinal axis, is configured to be displaced in a rotary manner about its longitudinal axis, and is configured to be displaced axially in the direction of its longitudinal axis via a stroke drive comprising a lifting rod, and which, at the back, is acted upon in the direction of its working plane by a support member, wherein the lifting rod and the support member are joined, via a carrier frame, to form a unit that is rotatable about the longitudinal axis of the working tool and mounted on the housing side, in which the carrier frame has guides, opposite one another transversely in relation to the working plane and running in the direction of the longitudinal axis, for a drive part of the stroke drive on the lifting rod side, to which the lifting rod is connected about a pivot axis running transversely in relation to the working plane.

2. The power tool as claimed in claim 1, wherein the support member is configured to be pivoted in relation to the carrier frame about an axis running transversely in relation to the working plane, and is configured to be displaced, driven in a pendulum manner, by a positioning drive.

3. The power tool as claimed in claim 1, wherein the carrier frame is mounted, on the housing side, so as to be rotatable about a longitudinal axis of the working tool.

4. The power tool as claimed in claim 3, further comprising a rotary drive, which acts on the carrier frame, and is configured to provide rotary displacement of the carrier frame.

5. The power tool as claimed in claim 1, wherein the stroke drive has a crank drive having, as a drive part on the lifting rod side, a yoke part that runs transversely in relation to the lifting rod and is pivotally connected to the lifting rod.

6. The power tool as claimed in claim 5, wherein the yoke part has a yoke guide, which runs transversely in relation to the working plane, and in which there engages an eccentric pin, which is provided on a drive wheel of the crank drive realized as an eccentric drive.

7. The power tool as claimed in claim 5, wherein the yoke part runs in a guide that extends in the direction of the longitudinal axis and that is constituted by guideways provided in longitudinal struts of the carrier frame that are opposite one another transversely in relation to the working plane.

8. The power tool as claimed in claim 6, wherein the eccentric pin is supported, via a needle bearing, in the yoke guide, in particular is realized as a needle bearing in its engagement part in relation to the yoke guide.

9. The power tool as claimed in claim 1, wherein a pivot lever is provided as a support member, which has a positioning sector that projects in the direction opposite to the working tool and that is located in the overlap region in relation to a drive element of the positioning drive that is positionally fixed to the housing.

10. The power tool as claimed in claim 9, wherein the drive element of the positioning drive constituting the pendulum drive is constituted by a positioning element that is stroke-displaceable parallelwise in relation to the longitudinal axis and that acts upon the positioning sector.

11. The power tool as claimed in claim 1, wherein the carrier frame is realized in the manner of a cage, having an upper and a lower carrier ring, which are connected to one another in a positionally fixed manner via longitudinal struts, and of which the lower carrier ring has carrier limbs that project in the direction of the working tool and on which the support member is supported.

12. The power tool as claimed in claim 11, wherein the carrier frame is mounted so as to be rotatable on the housing side via at least one of its carrier rings.

13. The power tool as claimed in claim 1, wherein the power tool has a carrier plate, on which there is provided, on the one hand, the positioning drive for the pendulum motion of the working tool and, on the other hand, the stroke drive of the working tool, with an associated working frame.

14. The power tool as claimed in claim 1, wherein the power tool is realized as a jigsaw having a saw blade as a working tool.

15. The power tool as claimed in claim 1, wherein the power tool is a hand-held power tool.

16. The power tool as claimed in claim 5, wherein the crank drive includes a Scotch-yoke crank drive.

17. The power tool as claimed in claim 12, wherein the carrier frame is mounted so as to be rotatable on the housing side via the upper carrier ring.
